(19) United States
(12) Patent Application Publication
(10) Pub. No.: US 2024/0087454 A1
(43) Pub. Date: Mar. 14, 2024

(54) CONDITION BASED ROADWAY ASSISTANCE

(71) Applicant: INTERNATIONAL BUSINESS MACHINES CORPORATION, ARMONK, NY (US)

(72) Inventors: Akash U. Dhoot, Pune (IN); Saraswathi Sailaja Perumalla, Visakhapatnam (IN); Sarbajit K. Rakshit, Kolkata (IN)

(21) Appl. No.: 17/930,443

(22) Filed: Sep. 8, 2022

(51) Int. Cl. G08G 1/0969; G08G 1/01; G08G 1/0967; G08G 1/16

(52) U.S. Cl. CPC G08G 1/0969; G08G 1/0112; G08G 1/0125; G08G 1/0141; G08G 1/0145; G08G 1/0967; G08G 1/164; G08G 1/166

(57) ABSTRACT

A method for load distribution on a roadway includes receiving roadway condition information for a portion of a roadway. The method also includes determining a load distribution on the portion of the roadway for current roadway conditions associated with the roadway condition information. In response to determining an action is required with respect to a first vehicle traveling on the portion of the roadway, the method also include determining whether the first vehicle is being operated in manual mode. In response to determining the first vehicle is being operated in manual mode, the method also includes determining guidance for an operator of the first vehicle to perform the action with respect to the load distribution on the portion of the roadway. The method also includes displaying, by the first vehicle, the guidance to the operator of the first vehicle.

### BACKGROUND

This disclosure relates generally to smart roadways, and in particular to providing condition-based roadway assistance to vehicles.

Roadway infrastructure is currently deploying smart roadway technology to improve on operational safety of traveling vehicles, sustainability, and traffic management. Smart roadways typically utilize Internet of Things (IoT) sensors, along with information and communication technology (ICT) to collect and analyze data for roadways being utilizing by various vehicles. Through edge computing, the analytics of the collected data is performed locally with reduced latency to ensure data collected by the smart roadway is relayed to the traveling vehicles in a timely manner, where an action can be taken by an operator of a traveling vehicle or the traveling vehicle itself.

### SUMMARY

Embodiments in accordance with the present invention disclose a method, computer program product and computer system for load distribution on a roadway, the method, computer program product and computer system can receive roadway condition information for a portion of a roadway. The method, computer program product and computer system can determine a load distribution on the portion of the roadway for current roadway conditions associated with the roadway condition information. The method, computer program product and computer system can, responsive to determining an action is required with respect to a first vehicle traveling on the portion of the roadway, determine whether the first vehicle is being operated in manual mode. The method, computer program product and computer system can, responsive to determining the first vehicle is being operated in manual mode, determine guidance for an operator of the first vehicle to perform the action with respect to the load distribution on the portion of the roadway. The method, computer program product and computer system can display, by the first vehicle, the guidance to the operator of the first vehicle.

### BRIEF DESCRIPTION OF THE SEVERAL VIEWS OF THE DRAWINGS

FIG. 1 is a functional block diagram illustrating a computing environment, in accordance with an embodiment of the present invention.

FIG. 2 depicts a flowchart of a roadway assistance program for managing load distribution of traveling vehicles on a roadway, in accordance with an embodiment of the present invention.

FIG. 3A depicts an illustrative example of a roadway assistance program displaying guidance for a vehicle to manage load distribution, in accordance with an embodiment of the present invention.

FIG. 3B depicts an illustrative example of a roadway assistance program displaying guidance for an alternate vehicle to manage load distribution, subsequent to a threshold distance being reached by an original vehicle, in accordance with an embodiment of the present invention.

FIG. 3C depicts an illustrative example an alternate vehicle performing an action subsequent to a threshold distance being passed by an original vehicle, in accordance with an embodiment of the present invention.

FIG. 4A depicts an illustrative example of a roadway assistance program displaying guidance for a vehicle to manage load distribution based on various vehicle properties, in accordance with an embodiment of the present invention.

FIG. 4B depicts an illustrative example a vehicle performing an action to manage load distribution based on various parameters, in accordance with an embodiment of the present invention.

FIG. 5A depicts an illustrative example of a roadway assistance program displaying an alert for a vehicle to manage load distribution utilizing an augmented reality electronic device on the vehicle, in accordance with an embodiment of the present invention.

FIG. 5B depicts an illustrative example of a roadway assistance program displaying an alert for a vehicle to manage load distribution utilizing smart headlights on the vehicle, in accordance with an embodiment of the present invention.

FIG. 5C depicts an illustrative example of a roadway assistance program displaying guidance for a vehicle to manage load distribution utilizing an augmented reality electronic device on the vehicle, in accordance with an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments. It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

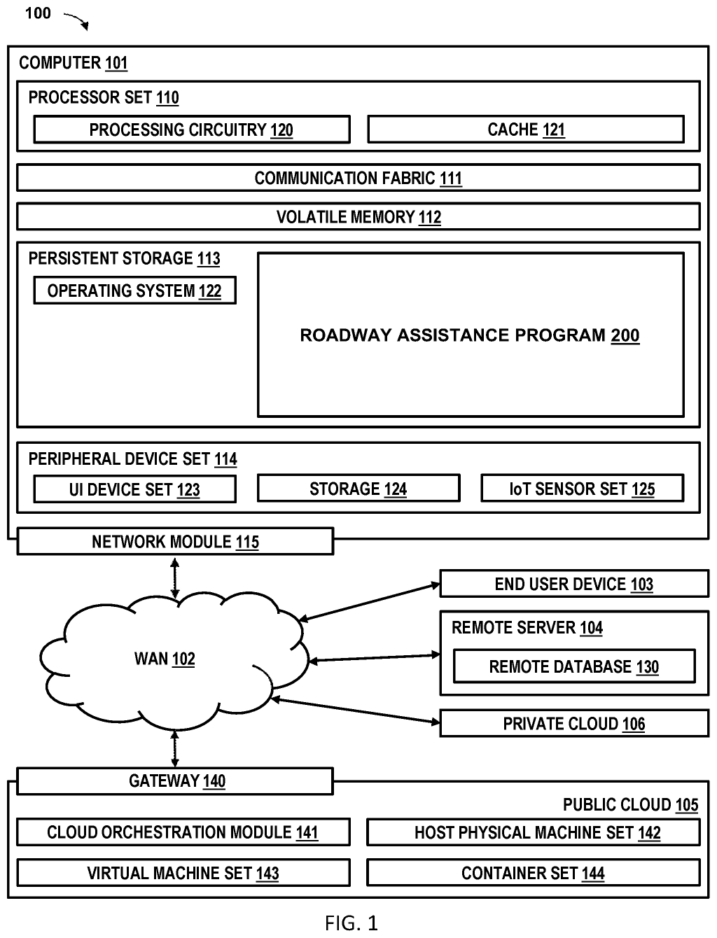

FIG. 1 is a functional block diagram illustrating a computing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computing environment 100 contains an example of an environment for the execution of at least some of the computer code involved in performing the inventive methods, such as roadway assistance program 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

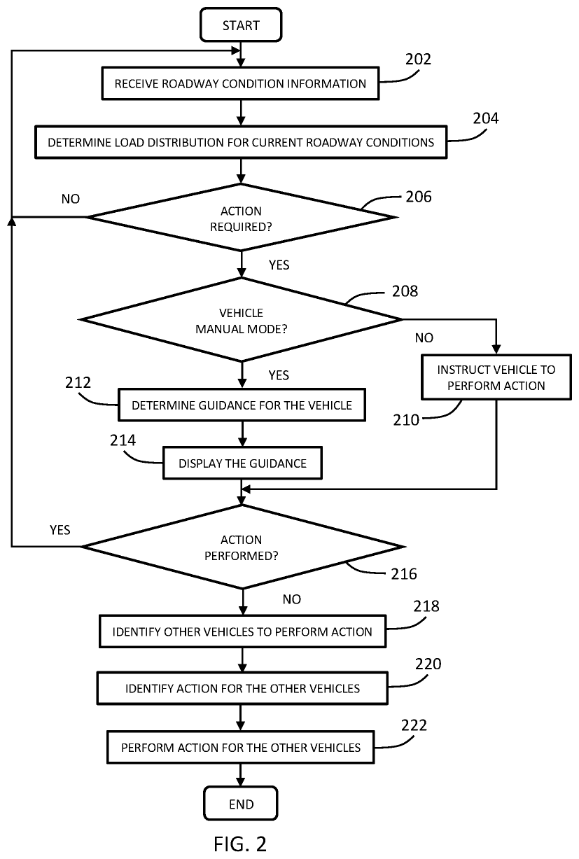

FIG. 2 depicts a flowchart of a roadway assistance program for managing load distribution of traveling vehicles on a roadway, in accordance with an embodiment of the present invention.

Roadway assistance program 200 receives roadway condition information (202). Utilizing localized edge servers in an edge computing environment enables roadway assistance program 200 to receive and analyze the roadway condition information for each portion of the roadway and provide the appropriate action to manage the load distribution of vehicles traveling on each portion of the roadway. In the edge computing environment, roadway assistance program 200 can receive a set amount of roadway condition information for a portion of a roadway to minimize latency when receiving and analyzing data associated with the various sensors, audio feeds, and video feeds for the portion of the roadway. The portion of the roadway can be based on length (e.g., one mile), roadway material (e.g., concrete, asphalt), environmental conditions (e.g., high heat, road salt), and/or roadway type (e.g., packed earth, truss bridge, suspension bridge). Roadway assistance program 200 can receive roadway condition information for each portion of the roadway and manage load distribution of vehicles traveling on each portion of the roadway.

Roadway assistance program 200 receives roadway condition information from various sensors, audio feeds, and video feeds for various portions of a roadway. Sensors can gather roadway condition information such as roadway surface temperatures, roadway moisture levels, roadway vibrations, and any other roadway information that roadway assistance program 200 can utilize to determine current roadway conditions. Roadway assistance program 200 can utilize the audio feed can gather sound wave profiles for vehicles traveling along the roadway, where the audio feed can capture sharp impact noises from potholes, vehicles driving on a wet roadway surface, vehicles traveling through standing water, and any vibrating noise resulting from a passing vehicle traveling on the roadway. Roadway assistance program 200 can utilize the video feed to determine a number of vehicles traveling in each lane of a roadway, a vehicle type (e.g., passenger vehicle, cargo van, tractor trailer) for each vehicle traveling on a roadway, vehicle speed for each vehicle traveling on a roadway, traffic conditions (e.g., light traffic, heavy traffic), a number of foreign object on the roadway surface, and instances of roadway damage (e.g., potholes, cracks, standing water).

Roadway assistance program 200 determines load distribution for current roadway conditions (204). Based on the received roadway condition information from the various sensors, audio feeds, and video feeds for each portion of the roadway, roadway assistance program 200 determines load distribution for each lane of each portion of the roadway for the current roadway conditions. Roadway assistance program 200 determines current roadway condition for each portion of the roadway by analyzing the associated sensor data, audio feed, and video feed. Load distribution can include directing, reducing, or eliminating lane traffic to avoid a foreign object (e.g., debris) in the lane, to reduce wear on a road surface, and/or to reduce propagation of a pothole. Reducing or eliminating lane traffic can include decreasing a number of vehicles traveling in a particular lane based on a percentage value (e.g., 75%) and/or decreasing a number of vehicles traveling in a particular lane based on vehicle properties via an action performable by an operator of the vehicle or by the vehicle itself (i.e., autonomous driving). Vehicle properties can include a number of axles on a vehicle, a number of tires on a vehicle, a gross weight of a vehicle, a vehicle type (e.g., passenger, bus, truck), a ground clearance height for a vehicle, and a sidewall height and/or ratio for tires on a vehicle.

In one example, roadway assistance program 200 receives roadway condition information that includes an audio and video feed of vehicles traveling along a two lane road. Roadway assistance program 200 analyzes the audio feed and determines that vehicles are impact a newly formed pothole in a portion of the roadway, based on a comparison to previously stored audio feeds for the same portion of the roadway that did not include any vehicle impact sounds. Roadway assistance program 200 analyzes the video feed and determines vehicles traveling along the two lane road are avoiding portions of a first lane (e.g., left lane), where vehicles are crossing over a painted line separating the first lane and a second lane of the two lane road. Based on the received roadway condition information from the audio and video feed, roadway assistance program 200 determines vehicle load on the first lane should be reduced and distributed to the second lane to prevent an accident and damage to vehicles traveling along the two lane road, until a repair is performed on the newly formed pothole in the first lane.

In another example, roadway assistance program 200 receives roadway condition information that includes sensor data measuring vibrations (e.g., accelerometer) on a bridge resulting from vehicles traveling along a portion of a roadway, along with a video feed for the portion of the roadway. Roadway assistance program 200 analyzes the sensor data and determines that the vibrations on the roadway are within safety parameters for the bridge but have exceeded an alert threshold (e.g., 75% of the maximum value for the safety parameters) a set number of times in a specified time frame (e.g., five times in the last ten minutes). Roadway assistance program 200 analyzes the video feed for the portion of the roadway where the alert threshold was exceeded and syncs the video feed with the sensor data measuring the vibrations. Based on the synced video feed with the sensor data, roadway assistance program 200 determines the set number of times in the specified time frame when the alert threshold was triggered occurred when a tractor trailer passed a location of the sensor on the bridge in the left lane. To preserve a lifecycle and reduce maintenance on the bridge, roadway assistance program 200 determines that vehicle load from tractor trailers should be reduced in the left lane to prevent excessive vibrations and reduce wear on the portion of the roadway with the bridge.

In yet another example, roadway assistance program 200 receives roadway condition information that includes a video feed for a portion of the roadway, wherein the video is directed to various sections and lanes of the portion of the roadway. Roadway assistance program 200 analyzes the video feed utilizing digital image processing and determines that a foreign object is present in a middle lane of a three lane highway, based on the foreign object being elevated above a planar surface of the middle lane of the three lane highway. Furthermore, based on the video analysis, roadway assistance program 200 determines passenger vehicles (e.g., sedans) avoid the foreign object by changing to another lane, but larger vehicles (e.g., trucks) do not change lanes when approaching and passing over the foreign object. Roadway assistance program 200 determines passenger vehicle load in the middle lane should be reduced and distributed to the other remaining two lanes of the three lane highway, but larger vehicle load in the middle lane can remain unchanged to prevent a full lane closure of the middle lane. For the all the examples discussed above, roadway assistance program 200 determines the load distribution for current roadway conditions and can subsequently alter the load distribution based on newly received roadway condition information and/or user input from an administrative user receivable by roadway assistance program 200 with overriding instructions to alter the load distribution for the roadway.

Roadway assistance program 200 determines whether an action is required for a vehicle based on the determined load distribution (decision 206). In another embodiment, roadway assistance program 200 determines an action is required for a vehicle based on the determined load distribution vehicles and matching vehicle properties. In event roadway assistance program 200 determines an action is required for the vehicle based on the determine load distribution (“yes” branch, decision 206), roadway assistance program 200 determines whether the vehicle is in manual mode (decision 208). In event roadway assistance program 200 determines an action is not required for the vehicle based on the determine load distribution (“no” branch, decision 206), roadway assistance program 200 reverts to receiving road condition information (202). Roadway assistance program 200 determines whether an action is required with regards to vehicles traveling along a portion of the roadway for which roadway assistance program 200 received roadway condition information and determined load distribution for current roadway condition.

From a previous example, roadway assistance program 200 determines vehicle load on a first lane should be reduced and distributed to a second lane to prevent an accident and damage to vehicles traveling along a two lane road, until a repair is performed on a newly formed pothole in the first lane. Roadway assistance program 200 determines an action is required for a vehicle based on a determination that the vehicle is traveling in the first lane towards a newly formed pothole. Roadway assistance program 200 can utilize the video feed from the received roadway condition information and/or can receive location information directly from the vehicles traveling along the portion of the roadway to determine an action is required based on the vehicle traveling in the first lane towards the newly formed pothole. From another previous example, roadway assistance program 200 determines that vehicle load from tractor trailers should be reduced in a left lane to prevent excessive vibrations and reduce wear on a portion of the roadway with the bridge. Roadway assistance program 200 determines an action is required for a tractor trailer traveling in the left lane along the portion of the roadway towards the bridge. Roadway assistance program 200 can utilize the video feed from the received roadway condition information and/or can receive location information directly from the vehicles traveling along the portion of the roadway to determine an action is required based on the tractor trailer traveling in the left lane. From yet another previous example, roadway assistance program 200 determines passenger vehicle load in a middle lane should be reduced to a foreign object on the roadway surface and distributed to two other remaining lanes of a three lane highway, but larger vehicle load in the middle lane can remain unchanged to prevent a full lane closure of the middle lane. Roadway assistance program 200 can utilize the video feed from the received roadway condition information and/or can receive location information directly from the vehicles traveling along the portion of the roadway to determine an action is required based on a passenger vehicle traveling in the middle lane where the foreign object is present.

Roadway assistance program 200 determines whether the vehicle is in manual mode (decision 208). For discussion purposes, manual mode represents a vehicle being operated by a user (i.e., operator) in a nonautonomous or semi-autonomous manner. A vehicle not in manual mode represents a vehicle being operated in an autonomous manner without input from the user. In event roadway assistance program 200 determines the vehicle is not in manual mode (“no” branch, decision 208), roadway assistance program 200 instructs the vehicle to perform an action (210). In event roadway assistance program 200 determines the vehicle is in manual mode (“yes” branch, decision 208), roadway assistance program 200 determines guidance for the vehicle (212).

Roadway assistance program 200 instructs the vehicle to perform an action (210). Based on the roadway assistance program 200 a determination that an action is required by the vehicle, roadway assistance program 200 instructs the vehicle to perform the action in an autonomous manner. From a previous example, roadway assistance program 200 determines an action is required for a vehicle based on a determination that the vehicle is traveling in the first lane towards a newly formed pothole. Roadway assistance program 200 can instruct the vehicle to perform an action to avoid the newly formed pothole in the first lane. Furthermore, roadway assistance program 200 can provide sub-actions to the vehicle including but not limited to instructing the vehicle to reduce a speed and/or relocate (i.e., change lanes) to a second lane on the two lane road, prior to a threshold distance to perform the action being crossed by the vehicle traveling in the first lane. From another previous example, roadway assistance program 200 determines an action is required for a tractor trailer traveling in the left lane along the portion of the roadway towards the bridge. Roadway assistance program 200 can instruct the tractor trailer traveling in the left lane to perform an action to avoid traveling in the left lane while crossing the bridge located in the portion of the roadway. Furthermore, roadway assistance program 200 can provide sub-actions to the tractor trailer including but not limited to instructing the tractor trailer to reduce a speed and/or relocate to another lane for this portion of the roadway with the bridge. From yet another previous example, roadway assistance program 200 determines an action is required based on a passenger vehicle traveling in the middle lane where a foreign object is present. Roadway assistance program 200 can instruct the vehicle to perform an action to avoid the foreign object present on a surface of middle lane for a portion of the roadway. Furthermore, roadway assistance program 200 can provide sub-actions to the vehicle including but not limited to instructing the vehicle to reduce a speed and/or relocate to the left lane or the right lane on the three lane highway that is the portion of the roadway with the foreign object present on a surface of the middle lane.

Roadway assistance program 200 determines guidance for the vehicle (212). Roadway assistance program 200 determines guidance for the vehicle being operated in a manual manner with respect to the determined load distribution for current roadway conditions. From a previous example, roadway assistance program 200 determines an action is required for a vehicle based on a determination that the vehicle is traveling in the first lane towards a newly formed pothole. Roadway assistance program 200 determines guidance for the operator of the vehicle to perform the action to avoid the newly formed pothole in the first lane, where the guidance can include display based guidance instructions for the operator to relocate to a second lane due to the vehicle approaching the newly formed pothole in the first lane. From another previous example, roadway assistance program 200 determines an action is required for a tractor trailer traveling in the left lane along the portion of the roadway towards the bridge. Roadway assistance program 200 determines guidance for the operator of the tractor trailer to perform the action to avoid traveling in the left lane while crossing the bridge located in the portion of the roadway, where the guidance can include display based guidance instructions for the operator to relocate to another lane prior to driving on the bridge. From yet another previous example, roadway assistance program 200 determines an action is required based on a passenger vehicle traveling in the middle lane where a foreign object is present. Roadway assistance program 200 determines guidance for the operator of the vehicle to perform the action to avoid the foreign object in the middle, where the guidance can include display based guidance instructions for the operator to relocate to another land (e.g., left lane or middle lane) due to the vehicle approaching the foreign object in the middle lane.

Roadway assistance program 200 displays the guidance (214). In one embodiment, roadway assistance program 200 displays the guidance in an augmented reality (AR) heads-up display (HUD), where the guidance is viewable in a windshield area by the operator of the vehicle. In another embodiment, roadway assistance program 200 displays the guidance in an augmented reality (AR) infotainment screen that includes a live video feed of a frontal field of view for the vehicle, where the guidance is viewable in the infotainment screen by the operator of the vehicle. In yet another embodiment, roadway assistance program 200 displays the guidance utilizing adaptive headlights on the vehicle, where the guidance is projected via the adaptive headlights onto a forward facing area and viewable by the operator of the vehicle. It is to be noted, that previously discussed examples can utilize one or more of the embodiments discussed above to display the guidance to an operator of the vehicle.

Roadway assistance program 200 determines whether the action was performed by the operator of the vehicle (decision 216). In the event roadway assistance program 200 determines the action was not performed by the operator of the vehicle (“no” branch, decision 216), roadway assistance program 200 identifies other vehicles to perform the action (218). In the event roadway assistance program 200 determines the action was performed by the operator of the vehicle (“yes” branch, decision 216), roadway assistance program 200 reverts to receiving road condition information (202). As previously discussed, roadway assistance program 200 can utilize a threshold distance to allow an operator to perform the action in a safe manner, where reaching or crossing the threshold distance indicates it is no longer safe for the operator of the vehicle to perform the action. For example, if there is a pothole in a lane of a roadway and a vehicle crosses the threshold distance, roadway assistance program 200 determines the action was not performed by the operator of the vehicle and doing so after crossing the threshold distance can result in a dangerous maneuver being performed by the operator or unavoidable impact with the pothole in the lane of the roadway.

Roadway assistance program 200 identifies other vehicles to perform an action (218). In this embodiment, roadway assistance program 200 identifies other vehicle with similar properties to the vehicle that did not perform the action prior to reaching the threshold distance. A previously discussed, vehicle properties can include a number of axles on a vehicle, a number of tires on a vehicle, a gross weight of a vehicle, a vehicle type (e.g., passenger, bus, truck), a ground clearance height for a vehicle, and a sidewall height and/or ratio for tires on a vehicle. Roadway assistance program 200 can also identify other vehicles to perform an action with a greater range of vehicle properties to compensate for the vehicle that did not perform the action. For example, roadway assistance program 200 previously determined a newly formed pothole is present in a left lane of a two lane roadway, where a vehicle weighing 5,500 lbs. did not perform an action to avoid traveling through the left lane with the pothole. Roadway assistance program 200 previously utilized a max gross weight limit of 6,000 lbs. as a vehicle property to determine an action was required for the vehicle that weighed 5,500 lbs. Roadway assistance program 200 can lower a gross weight limit for a vehicle traveling along the portion of the roadway to 5,000 lbs. for a predetermined amount of time (e.g., 2 minutes) to compensate for the vehicle weighing 5,5001 lbs. that did not perform an action to avoid traveling through the left lane with the pothole. In other embodiments, roadway assistance program 200 can identify other vehicles to perform the action located in an adjacent portion of the roadway to allow the other vehicles additional time to perform the action. As previously discussed, a portion of a roadway can be distance based, for example, 0.5 miles. An adjacent portion of the roadway would include a 0.5 mile long section of roadway located prior to a 0.5 mile long portion of the roadway along the direction of travel, where an action by the vehicle was not performed.

Roadway assistance program 200 identifies an action for the other vehicles (220). From a previous example, roadway assistance program 200 determines vehicle load on a first lane should be reduced and distributed to a second lane to prevent an accident and damage to vehicles traveling along a two lane road, until a repair is performed on a newly formed pothole in the first lane. Roadway assistance program 200 determines an action is required for the other vehicles based on a determination that the other vehicles are traveling in the first lane towards a newly formed pothole. Roadway assistance program 200 can utilize the video feed from the received roadway condition information and/or can receive location information directly from the other vehicles traveling along the portion of the roadway to determine an action is required based on the other vehicles traveling in the first lane towards the newly formed pothole. From another previous example, roadway assistance program 200 determines that vehicle load from tractor trailers should be reduced in a left lane to prevent excessive vibrations and reduce wear on a portion of the roadway with the bridge. Roadway assistance program 200 determines an action is required for other tractor trailers traveling in the left lane along the portion of the roadway towards the bridge. Roadway assistance program 200 can utilize the video feed from the received roadway condition information and/or can receive location information directly from the other tractor trailers traveling along the portion of the roadway to determine an action is required based on the other tractor trailers traveling in the left lane. From yet another previous example, roadway assistance program 200 determines passenger vehicle load in a middle lane should be reduced to a foreign object on the roadway surface and distributed to two other remaining lanes of a three lane highway, but larger vehicle load in the middle lane can remain unchanged to prevent a full lane closure of the middle lane. Roadway assistance program 200 can utilize the video feed from the received roadway condition information and/or can receive location information directly from the other passenger vehicles traveling along the portion of the roadway to determine an action is required based on other passenger vehicles traveling in the middle lane where the foreign object is present.

Roadway assistance program 200 performs an action for the other vehicles (222). Due to the other vehicles being positioned behind the vehicle that did not perform the action but traveling in the same direction, roadway assistance program 200 initially displays the guidance previously presented in the vehicle that did not perform an action, previously discussed in (212) and (214). As each of the other vehicles approaches closer to the distance threshold, roadway assistance program 200 can determine whether each of the other vehicles are operating in a manual mode. For another vehicle not operating in manual mode (i.e., autonomous), roadway assistance program 200 instructs the other vehicle to perform the action as previously discussed in (210) with respect to the vehicle that did not perform the action. For another vehicle operating in manual mode (i.e., semiautonomous or nonautonomous), roadway assistance program 200 continues to display the guidance in the other vehicle as previously discussed in (212) and (214) with respect to the vehicle that did perform the action.

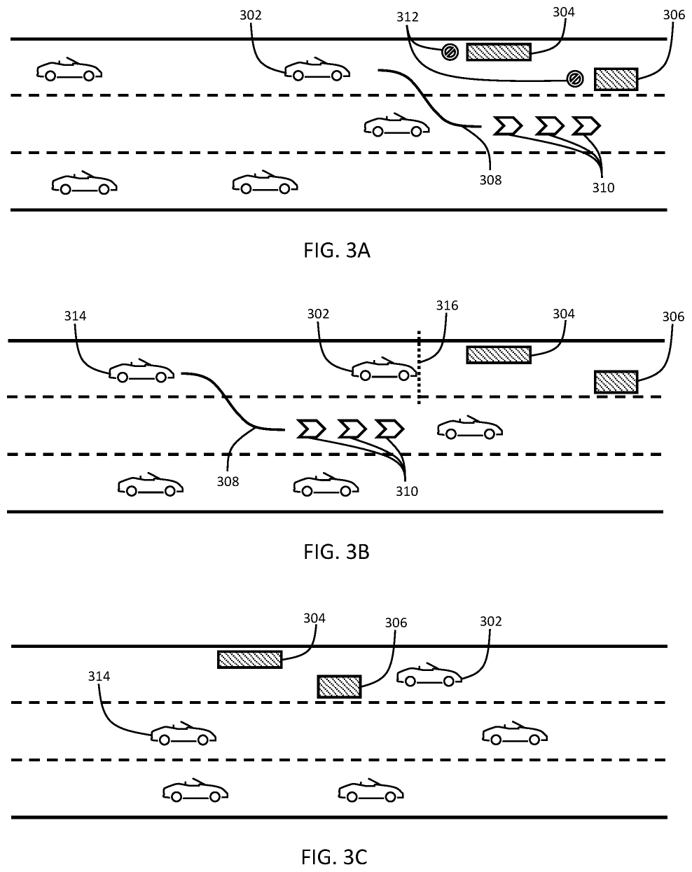

FIG. 3A depicts an illustrative example of a roadway assistance program displaying guidance for a vehicle to manage load distribution, in accordance with an embodiment of the present invention. In this example, vehicle 302 is traveling in a left lane on a three lane roadway, where roadway assistance program 200 receives road condition information indicating potholes 304 and 306 are present in the left lane. Roadway assistance program 200 determines an action is required by vehicle 302 and determines vehicle 302 is operating in manual mode, where the operator is controlling vehicle 302 in a nonautonomous manner. Roadway assistance program 200 determines guidance for vehicle 302 based on potholes 304 and 306 and displays the guidance utilizing an augmented reality (AR) heads-up display (HUD), where guidance line 308 and directional arrows 310 appear to the operator of vehicle 302 to be projected on a surface of the roadway to the operator of vehicle 302. Roadway assistance program 200 also displays warning symbols 312 ahead of potholes 304 and 306 to draw the operator's attention to the roadway condition.

FIG. 3B depicts an illustrative example of a roadway assistance program displaying guidance for an alternate vehicle to manage load distribution, subsequent to a threshold distance being reached by an original vehicle, in accordance with an embodiment of the present invention. In this example, vehicle 302 reaches distance threshold 316 and roadway assistance program 200 determines no action was performed by vehicle 302 to avoid potholes 304 and 306. Distance threshold 316 represents a tolerance limit for an operator to safely take action to avoid potholes 304 and 306 by relocating to an adjacent lane on the roadway. Roadway assistance program 200 identifies another vehicle 314 traveling in the same lane of the roadway as vehicle 302 and identifies an action for vehicle 314 as the similar to the action that was not taken by vehicle 302, however vehicle 314 includes additional time to perform the action when compared to vehicle 302. Roadway assistance program 200 displays guidance line 308 and directional arrows 310 to an operator of vehicle 314, where an operator of vehicle 314 can perform the action of relocating to another lane on the roadway.

FIG. 3C depicts an illustrative example an alternate vehicle performing an action subsequent to a threshold distance being passed by an original vehicle, in accordance with an embodiment of the present invention. In this example, vehicle 314 successfully performs the action and relocates to an adjacent lane to avoid potholes 304 and 306, while vehicle 302 continued to travel in the same lane towards potholes 304 and 306.

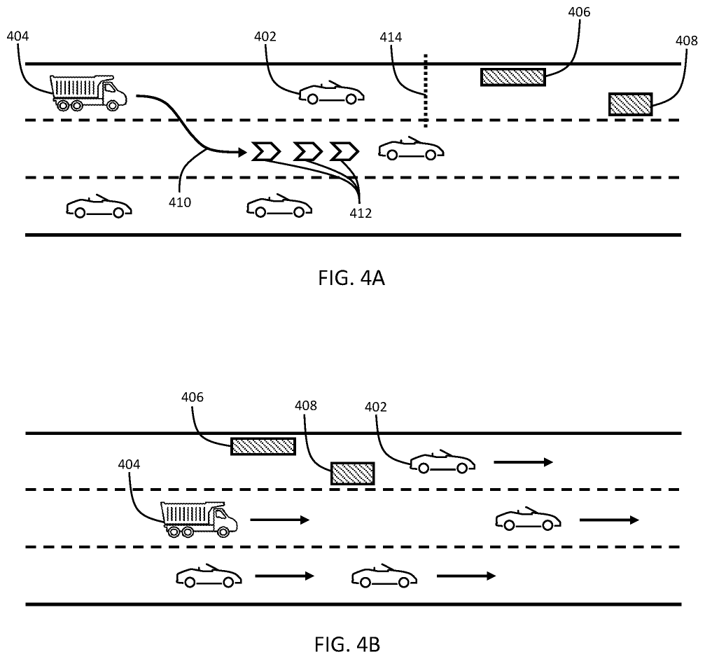

FIG. 4A depicts an illustrative example of a roadway assistance program displaying guidance for a vehicle to manage load distribution based on various vehicle properties, in accordance with an embodiment of the present invention. In this example, vehicle 402 and truck 404 are traveling in a left lane on a three lane roadway, where roadway assistance program 200 receives road condition information indicating potholes 406 and 408 are present in the left lane. Roadway assistance program 200 determines an action is required by truck 404 but not vehicle 402 due to different vehicle properties, where roadway assistance program 200 determines the gross weight of truck 404 is 15000 lbs. and the gross weight of vehicle 402 is 4000 lbs. Roadway assistance program 200 determines the gross weight of vehicle 402 is below a set threshold to prevent additional damage to potholes 406 and 408, but the higher gross weight of truck 404 exceeds the set threshold and can potentially cause more damage to potholes 406 and 408. Roadway assistance program 200 determines truck 404 is operating in manual mode, where the operator is controlling truck 404 in a nonautonomous manner. Roadway assistance program 200 determines guidance for truck 404 based on potholes 406 and 408 and displays the guidance utilizing an augmented reality (AR) heads-up display (HUD), where guidance line 410 and directional arrows 412 appear to the operator of truck 404 to be projected on a surface of the roadway to the operator of truck 404. Distance threshold 414 represents a point where roadway assistance program 200 determines whether the action to relocate to another lane was performed by an operator of truck 404.

FIG. 4B depicts an illustrative example a vehicle performing an action to manage load distribution based on various parameters, in accordance with an embodiment of the present invention. In this example, truck 404 successfully performs the action and relocates to an adjacent lane to avoid potholes 406 and 408, while vehicle 402 continued to travel in the same lane towards potholes 406 and 408

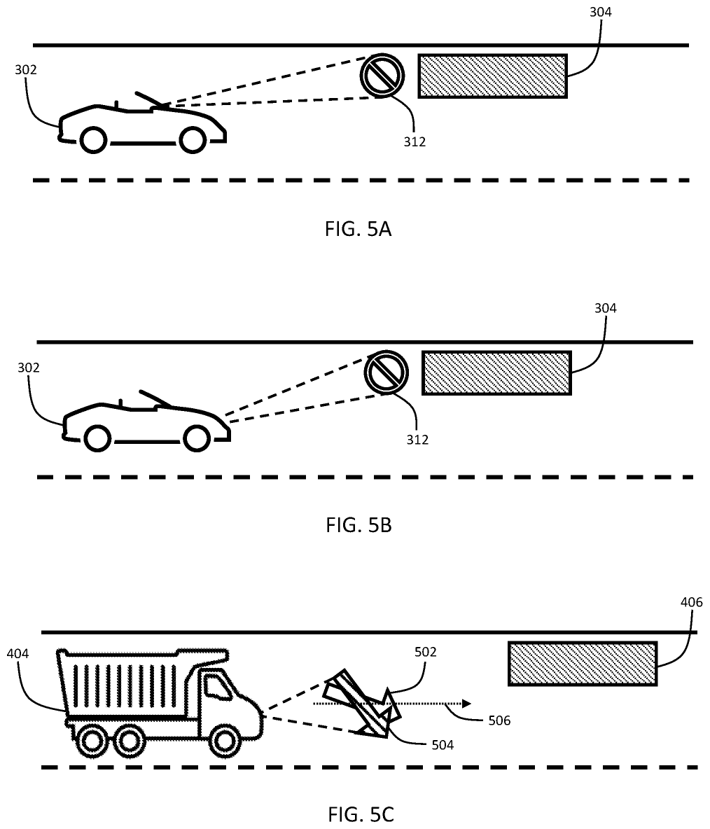

FIG. 5A depicts an illustrative example of a roadway assistance program displaying an alert for a vehicle to manage load distribution utilizing an augmented reality electronic device on the vehicle, in accordance with an embodiment of the present invention. From the example previously described with regards to FIG. 3A, roadway assistance program 200 displays warning symbol 312 ahead of pothole 304 to draw the operator's attention to the roadway condition. Roadway assistance program 200 displays warning symbol 312 in an augmented reality (AR) heads-up display (HUD) on vehicle 302, where warning symbol 312 (along with guidance line 308 and directional arrows 310, not illustrated in FIG. 5A) is viewable in a windshield area by the operator of vehicle 302.

FIG. 5B depicts an illustrative example of a roadway assistance program displaying an alert for a vehicle to manage load distribution utilizing smart headlights on the vehicle, in accordance with an embodiment of the present invention. From the example previously described with regards to FIG. 3A, roadway assistance program 200 displays warning symbol 312 ahead of pothole 304 to draw the operator's attention to the roadway condition. However, in this example, roadway assistance program 200 displays warning symbol 312 utilizing adaptive headlights on vehicle 302 to project warning symbol 312 (along with guidance line 308 and directional arrows 310, not illustrated in FIG. 5A) onto a surface of the left lane on the roadway. As vehicle 302 approaches pothole 304, roadway assistance program 200 instructs the adaptive headlights to project warning symbol 312 at a fixed location, where the adaptive headlights adjust which pixels are activated to create the projection of warning symbol 312 at the fixed location.

FIG. 5C depicts an illustrative example of a roadway assistance program displaying guidance for a vehicle to manage load distribution utilizing an augmented reality electronic device on the vehicle, in accordance with an embodiment of the present invention. From the example previously described with regards to FIG. 4A, roadway assistance program 200 can display an automated directional arrow at first position 502 ahead of pothole 406 to draw the operator's attention to the roadway condition and an action to be performed. Roadway assistance program 200 displays the automated directional arrow at first position 502 utilizing adaptive headlights on truck 404 to project the automated directional arrow onto a surface of the left lane on the roadway. As truck 404 approaches pothole 406, roadway assistance program 200 instructs the adaptive headlights to rotate the automated directional arrow to second position 504 and increase an angle of the automated direction arrow with respect to centerline 506 representing a direction of travel of truck 404.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving roadway condition information for a portion of a roadway;
determining a load distribution on the portion of the roadway for current roadway conditions associated with the roadway condition information;
responsive to determining an action is required with respect to a first vehicle traveling on the portion of the roadway, determining whether the first vehicle is being operated in manual mode;
responsive to determining the first vehicle is being operated in manual mode, determining guidance for an operator of the first vehicle to perform the action with respect to the load distribution on the portion of the roadway; and
displaying, by the first vehicle, the guidance to the operator of the first vehicle.

2. The method of claim 1, further comprising:
responsive to determining the action was not performed by the first vehicle, identifying a second vehicle traveling on the portion of the roadway;
identifying another action for the second vehicle to perform with respect to the load distribution on the portion of the roadway, wherein the other action includes displaying the guidance to an operator of the second vehicle; and
performing, the other action, for the second vehicle.

3. The method of claim 2, further comprising:
responsive to determining a distance threshold by the first vehicle is reached, determining whether the action was performed by the first vehicle,
wherein the distance threshold represents a tolerance limit for the operator of the first vehicle to perform the action to avoid a road condition.

4. The method of claim 3, wherein the load distribution on the portion of the roadway avoids a lane of travel with the road condition selected from the group consisting of: a foreign object and a pothole.

5. The method of claim 1, wherein the load distribution on the portion of the roadway is based on vehicle properties for a plurality of vehicles that includes the first vehicle traveling along the portion of the roadway.

6. The method of claim 5, wherein the vehicle properties are selected from the group consisting of: a number of axles on each vehicle from the plurality of vehicles, a number of tires on each vehicle from the plurality of vehicles, a gross weight of each vehicle from the plurality of vehicles, a vehicle type for each vehicle from the plurality of vehicles, a ground clearance height of each vehicle from the plurality of vehicles, and a sidewall ratio for the tires on each vehicle from the plurality of vehicles.

7. The method of claim 1, wherein the roadway condition information includes data from a plurality of sensors, an audio feed, and a video feed for the portion of the roadway.

8. A computer program product comprising:
one or more computer-readable storage media and program instructions stored on the one or more computer-readable storage media capable of performing a method, the method comprising:
receiving roadway condition information for a portion of a roadway;
determining a load distribution on the portion of the roadway for current roadway conditions associated with the roadway condition information;
responsive to determining an action is required with respect to a first vehicle traveling on the portion of the roadway, determining whether the first vehicle is being operated in manual mode;
responsive to determining the first vehicle is being operated in manual mode, determining guidance for an operator of the first vehicle to perform the action with respect to the load distribution on the portion of the roadway; and
displaying, by the first vehicle, the guidance to the operator of the first vehicle.

9. The computer program product of claim 8, further comprising:
responsive to determining the action was not performed by the first vehicle, identifying a second vehicle traveling on the portion of the roadway;
identifying another action for the second vehicle to perform with respect to the load distribution on the portion of the roadway, wherein the other action includes displaying the guidance to an operator of the second vehicle; and
performing, the other action, for the second vehicle.

10. The computer program product of claim 9, further comprising:
responsive to determining a distance threshold by the first vehicle is reached, determining whether the action was performed by the first vehicle,
wherein the distance threshold represents a tolerance limit for the operator of the first vehicle to perform the action to avoid a road condition.

11. The computer program product of claim 10, wherein the load distribution on the portion of the roadway avoids a lane of travel with the road condition selected from the group consisting of: a foreign object and a pothole.

12. The computer program product of claim 8, wherein the load distribution on the portion of the roadway is based on vehicle properties for a plurality of vehicles that includes the first vehicle traveling along the portion of the roadway.

13. The computer program product of claim 12, wherein the vehicle properties are selected from the group consisting of: a number of axles on each vehicle from the plurality of vehicles, a number of tires on each vehicle from the plurality of vehicles, a gross weight of each vehicle from the plurality of vehicles, a vehicle type for each vehicle from the plurality of vehicles, a ground clearance height of each vehicle from the plurality of vehicles, and a sidewall ratio for the tires on each vehicle from the plurality of vehicles.

14. The computer program product of claim 8, wherein the roadway condition information includes data from a plurality of sensors, an audio feed, and a video feed for the portion of the roadway.

15. A computer system comprising:
one or more computer processors, one or more computer-readable storage media, and program instructions stored on the one or more of the computer-readable storage media for execution by at least one of the one or more processors capable of performing a method, the method comprising:
receiving roadway condition information for a portion of a roadway;
determining a load distribution on the portion of the roadway for current roadway conditions associated with the roadway condition information;
responsive to determining an action is required with respect to a first vehicle traveling on the portion of the roadway, determining whether the first vehicle is being operated in manual mode;
responsive to determining the first vehicle is being operated in manual mode, determining guidance for an operator of the first vehicle to perform the action with respect to the load distribution on the portion of the roadway; and
displaying, by the first vehicle, the guidance to the operator of the first vehicle.

16. The computer system of claim 15, further comprising:
responsive to determining the action was not performed by the first vehicle, identifying a second vehicle traveling on the portion of the roadway;
identifying another action for the second vehicle to perform with respect to the load distribution on the portion of the roadway, wherein the other action includes displaying the guidance to an operator of the second vehicle; and
performing, the other action, for the second vehicle.

17. The computer system of claim 16, further comprising:
responsive to determining a distance threshold by the first vehicle is reached, determining whether the action was performed by the first vehicle,
wherein the distance threshold represents a tolerance limit for the operator of the first vehicle to perform the action to avoid a road condition.

18. The computer system of claim 17, wherein the load distribution on the portion of the roadway avoids a lane of travel with the road condition selected from the group consisting of: a foreign object and a pothole.

19. The computer system of claim 15, wherein the load distribution on the portion of the roadway is based on vehicle properties for a plurality of vehicles that includes the first vehicle traveling along the portion of the roadway.

20. The computer system of claim 19, wherein the vehicle properties are selected from the group consisting of: a number of axles on each vehicle from the plurality of vehicles, a number of tires on each vehicle from the plurality of vehicles, a gross weight of each vehicle from the plurality of vehicles, a vehicle type for each vehicle from the plurality of vehicles, a ground clearance height of each vehicle from the plurality of vehicles, and a sidewall ratio for the tires on each vehicle from the plurality of vehicles.
